(19) United States
(12) Patent Application Publication
(10) Pub. No.: US 2008/0239896 A1
(43) Pub. Date: Oct. 2, 2008

(54) GENERATION METHOD OF CLOCK SIGNAL OF PATTERNED MEDIUM, PATTERNED MEDIUM AND STORAGE DEVICE

(75) Inventor: Sumio Kuroda, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/056,667

(22) Filed: Mar. 27, 2008

(30) Foreign Application Priority Data
Mar. 28, 2007 (JP) 2007-084697

(51) Int. Cl. G11B 5/09

(52) U.S. Cl. 369/47.48

(57) ABSTRACT

A clock generation method detects from servo signals a degree of decentering of a patterned medium having recording pits arranged in a circular pattern and changes a clock frequency for recording/reproduction based on the detected degree of decentering.

This application describes a generation method of a patterned medium clock, a patterned medium and a storage device, and specifically relates to the generation method of the patterned medium clock that can accurately synchronize to a pattern without any loss in a format efficiency, the patterned medium and the storage device.

### BACKGROUND

In recording data onto a conventional medium having a continuous recording layer, a signal is recorded on the medium regardless of positions of recording pits thereon by using a clock of the storage device. While reproducing the data, a reproduction clock is synchronized to the recording pits.

On a patterned medium, the data recording positions are specified on a pits basis. Therefore, data should be recorded to the specified positions for accurate data recording.

In of the methods for recording data exactly on the target patterns, a method for forming a great number of patterns for a clock synchronous on the medium has been developed (e.g., Japanese Laid-open Patent Publication 2003-157507).

Furthermore, as a method for producing a mass-producible patterned medium, a method using nanoimprint-mold imprinting has been invented, which may readily realize a mass-production of the patterned medium.

However, creating a great number of patterns for the clock synchronous on the medium will reduce format efficiency, as might be expected.

Whereas, with the nanoimprint method, on the order of submicromilimeter absolute circularity error in a radius direction and a circumferential direction, i.e., a high-order decentering, results on the patterned medium in removing the mold. As such, if data is recorded on or reproduced from such medium produced thereby by a certain frequency clock as in the conventional fashion, the pattern on the medium and the clock for recording/reproduction become asynchronous.

However, a relative position accuracy in the radius direction and in the circumferential direction can be kept.

Accordingly, an object of this invention is to generate the true recording/reproduction clock to the pattern formed on a data region of the patterned medium without reducing the format efficiency as much as possible.

### SUMMARY

In accordance with an aspect of embodiments, a clock generation method detects from servo signal a degree of decentering of a patterned medium having recording pits arranged in a circular pattern corresponding a zone therein and changes a clock frequency for recording/reproduction based on the detected degree.

In accordance with another aspect of embodiments, a patterned medium has a plurality of concentric tracks divided into a plurality of zones in a radial direction, recording pits arranged along said tracks in a pattern corresponding the zone therein, and repeatable run-out (RRO) information recording in a servo region of the zone.

### BRIEF DESCRIPTION OF THE DRAWINGS

FIG. 1 is a diagram of a patterned medium.

FIG. 2 illustrates a first-half of a patterned medium production processes in a first embodiment.

FIG. 3 illustrates a last-half of the patterned medium production processes in the first embodiment.

FIG. 4 shows a servo pattern and a patterned medium pits pattern on the patterned medium.

FIG. 5 shows a schematic plan view of a magnetic disk device in the first embodiment.

FIG. 6 illustrates a decentering between rotation axes of the patterned medium and a spindle motor.

FIG. 7 shows a relationship between the circumferential direction and a frequency where the patterned medium is decentered.

FIG. 8 shows a correlation of a head position and current.

FIG. 9 illustrates a displacement of a writing/reading head attributed to a yawing angle β.

FIG. 10 shows a clock generator circuit in the first embodiment.

FIG. 11 shows a servo pattern and a patterned medium pit pattern on the patterned medium in a second embodiment.

FIG. 12 shows the clock generator circuit in the second embodiment.

### DETAILED DESCRIPTION

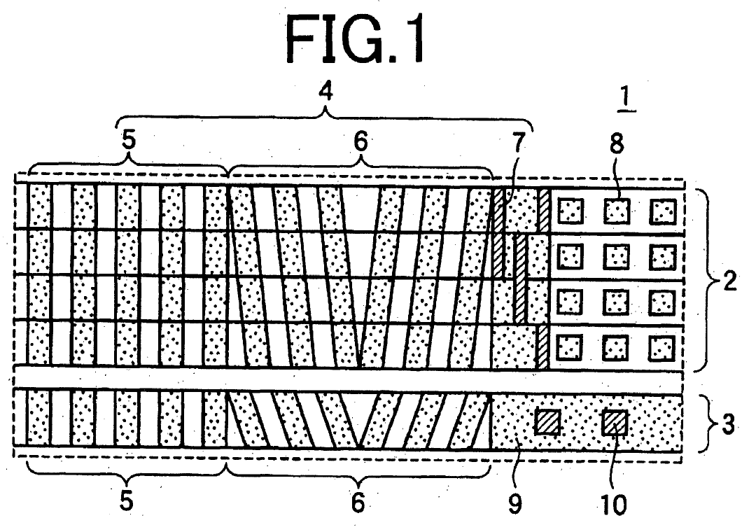

FIG. 1 shows the principle structure of the patterned medium. Referring to FIG. 1, a way of achieving the aforementioned aim will be discussed here.

In FIG. 1, reference characters 5 and 6 denote a clock synchronous pattern and a servo pattern respectively.

In the patterned medium clock generation method presented in this application, a drive of a storage device loads a patterned medium 1 on which recording pits 8 are formed in the circumferential direction at regular intervals for each zone 2; a degree of the decentering of the patterned medium 1 is measured by a servo signal; a clock frequency for recording/reproduction is adjusted based on the degree of the decentering measured.

In this manner, the clock frequency for recording/reproduction for each zone 2 is accommodated based on the degree of the decentering. In this manner, writing information onto the recording pits 8 formed on the patterned medium 1 at regular intervals for each zone 2 in parallel with reading the written information is accomplished with high reproducibility.

In adjusting the clock frequency for recording/reproduction, it is preferable to measure a displacement of the reading/writing head in the circumferential direction to generate a writing clock signal that compensates an amount of delay attributed to the displacement measured.

Thus, determining an exact timing for writing requires measuring a position error of the reading/writing head attributed to the yaw angle, reflecting the position error as a delay compensation to the writing clock.

Since the yaw angle differs depending upon where the head is in the radius direction, the amount of the delay compensation should be adjusted for each zone 2.

Further, it is preferable to reflect high-order decentering information of tracks to data recording/reproduction frequency in changing the clock frequency for recording/reproduction.

The distortion of the patterned medium attributed to imprinting such as the nanoimprimt, i.e., the high-order decentering, has a certain relationship between the radius direction and the circumferential direction. Therefore, RRO (repeatable run-out) data in the radius direction is adapted to a change of the clock frequency in the circumferential direction, which is then reflected to the recording/reproduction frequency.

In patterned medium that has record pit regions formed circumferentially at certain pattern intervals for each zone 2 partitioned along a concentric annulus, RRO information 7 is stored in a servo region formed in each zone 2.

Thus, for the patterned medium, changing the clock frequency for recording/reproduction for each zone 2 is facilitated by storing the RRO information 7 in a servo region 4 formed in each zone 2.

It is preferable to set a continuous recording medium region in a boundary 3 of each zone 2 in conjunction with setting an isolated pattern to measure the position error of the reading/writing head in the circumferential direction in the continuous recording medium region. In this manner, the position error is detected as a pattern of “0s” and “1s”, determined precisely the amount of the position error of the reading/writing head in the circumferential direction attributed to the yawing angle.

A highly accurate reproduction can be achieved by: measuring the degree of decentering of the patterned medium 1 by loading the patterned medium 1 in the drive and examining the servo signal; and having a clock frequency control mechanism to change the clock frequency for recording/reproduction based on the degree of decentering measured.

For accurate reproduction, it is preferable to have a frequency table providing a relationship between the degree of the decentering and the frequency for each zone 2, so that the clock frequency for recording/reproduction can be readily adjusted based on the degree of the decentering fed back by a PLL (phase-locked loop).

It is also desirable to have two tables based on the decentering data measured: a table of coefficients in the radius direction, i.e., the table of the RRO data attributed to the yawing angle; and a table of coefficients in the circumferential direction, i.e., the table of the data relating to the clock synchronous pattern. This appropriately compensates or adjusts the displacement of the head in the radius direction attributed to the yawing angle.

With this application, the asynchronous relationship between the frequency in a sector and the recording pit pattern formed on the patterned medium can be avoided by feeding back decentering compensation data to adjust the frequency for recording/reproduction. Thereby, a longer sector, raising the format efficiency.

The storage device presented in this application loads the patterned medium on which the recording pits are formed in the circumferential direction at regular intervals for each zone in its drive, measuring the degree of decentering of the patterned medium by the servo signal, and adjusting the clock frequency for recording/reproduction based on the degree of the decentering measured.

In order to compensate for the writing timing-asynchronous condition caused by the displacement of the reading/writing head in the circumferential direction attributed to the yawing angle, the isolated pattern is formed in the continuous recording medium region set in the boundaries of each zone, and displacement of the head is measured by reading the isolated pattern. Then the writing clock compensated for the amount of the delay attributed to the displacement measured is generated.

Further, in adjusting the clock frequency for recording/reproduction, in order to reflect the high-order decentering information of the tracks in the data recording/reproduction frequency the recording pits are formed circumferentially at regular intervals for each zone partitioned in a concentric fashion. The RRO information is recorded in the servo regions formed in each zone, and the RRO information is output to a RRO/zone frequency conversion controller in data recording/reproducing, the frequency being compensated based on the data.

### THE FIRST EMBODIMENT

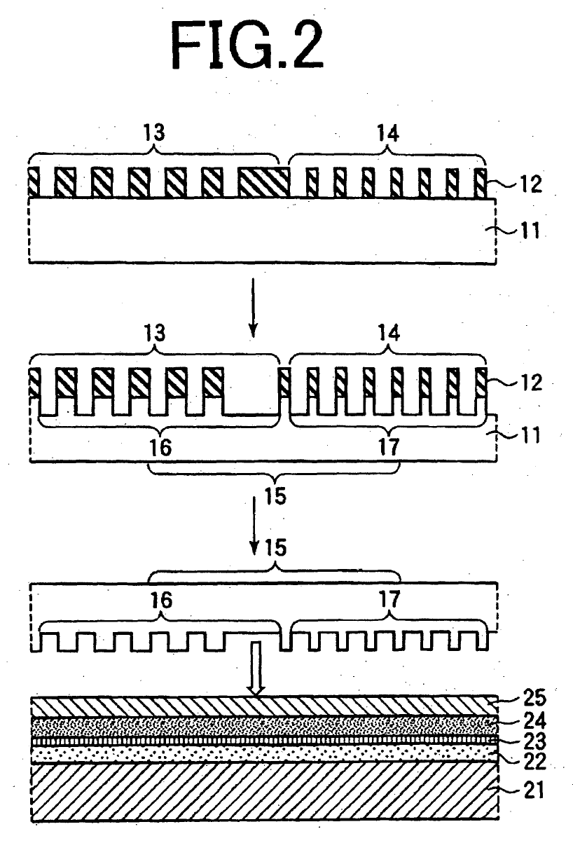

Here, referring to FIG. 2-10, the generation method of the patterned medium clock in the first embodiment will be discussed.

As in a production process of a stamper for the optical disk, a resist pattern 12 (FIG. 2) is formed by: coating an electron beam resist on, e.g., a 8-inch silicon wafer 11; and writing and developing information corresponding to a servo pattern 13 and a patterned medium pit pattern 14 which are synchronous with the true clock described in Japanese Laid-Open Patent Publication No. 2003-157507 by an electron beam exposure device.

Then, using the resist pattern 12 as a mask, exposed areas of the silicon wafer 11 are etched to 100 nm in depth (or another suitable arbitrary depth) by reactive ion etching using, e.g., SF6 gas, to form a nanoimprint mold 15 on which a servo pattern 16 and a patterned medium pit pattern 17 are formed. While on a glass substrate 21, from bottom to top, a magnetic layer comprising a backing layer 22, an inner layer 23 and a magnetic recording layer 24 are deposited. Then a PMMA (polymethylmethacrylate) layer 25 is coated thereon, and then the mold 15 is imprinted on the PMMA layer 25 to produce a perpendicular medium.

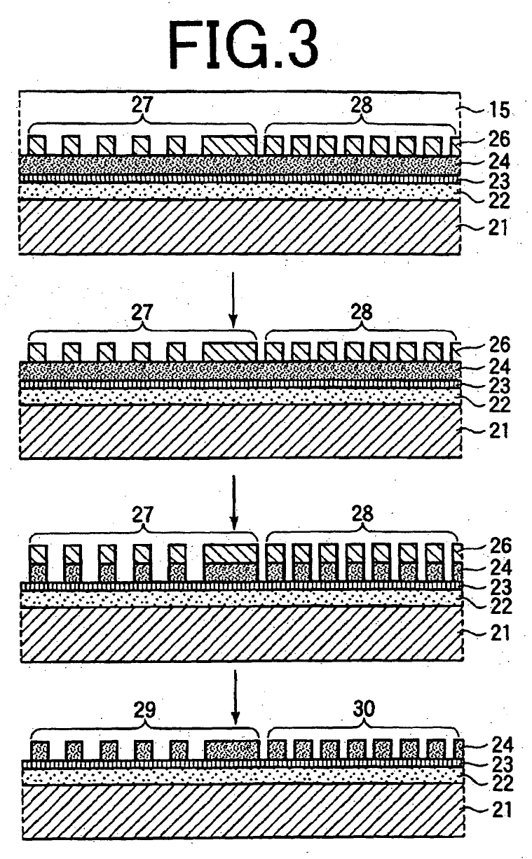

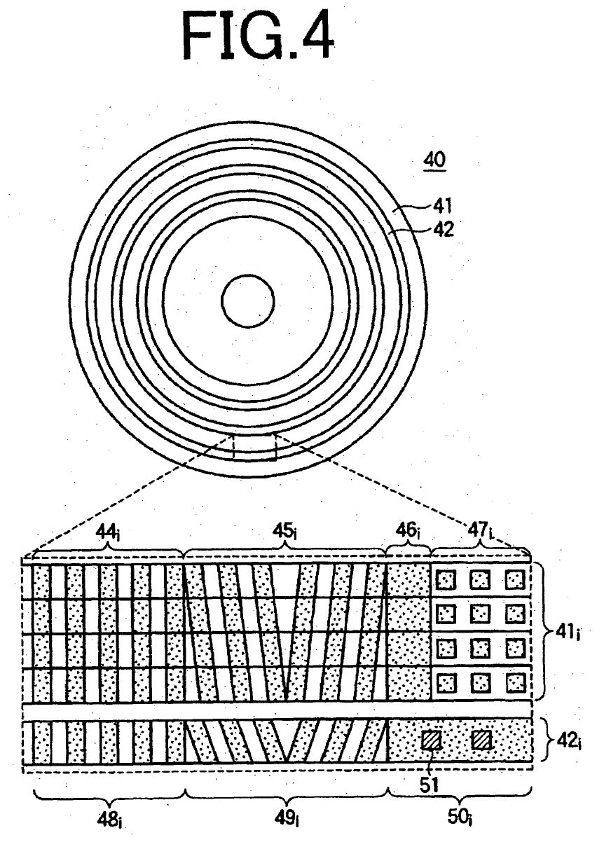

Thus, a PMMA mask 26 (FIG. 3) having a servo pattern 27 and a patterned medium pit pattern 28 is formed. Then using the PMMA mask 26, the exposed areas of the magnetic layer are etched, at least, to the inner layer 23 by the reactive ion etching, thereby producing a patterned medium 40 (FIG. 4) having a servo pattern 29 and a patterned medium pit pattern 30 thereon.

FIG. 4 shows the servo pattern and the patterned medium pit pattern on the patterned medium. The patterned medium 40 is, e.g., partitioned into 100 concentric zones 41. Adjacent each boundary zone 41, a boundary region 42 is formed. This is because of the resolution required to synchronize the clock to the patterns on the medium. Thus, 100 or more zones on a 2.5-inch disk is preferable.

Each zone 41i is constructed from a servo pattern 29 comprising a clock synchronous pattern 44i, a servo pattern 45i for positioning the head to a track and a continuous recording medium region 46i wherein the RRO data is written, and a recording pit region 47i wherein the patterned medium pit pattern 30 is formed. The clock synchronous pattern 44i and the servo pattern 45i in each zone 41i have common frequencies. The pit pattern 30 is formed at regular intervals, but the intervals differ from one zone 41i to another zone 41i.

While, in each boundary region 42i, a clock synchronous pattern 48i and a servo pattern 49i with the same frequency of the zones 41i are formed. A residual region is for a continuous recording medium region 50i wherein, as described later, an isolated pattern 51 is written magnetically in order to measure the amount of displacement of the reading/writing head.

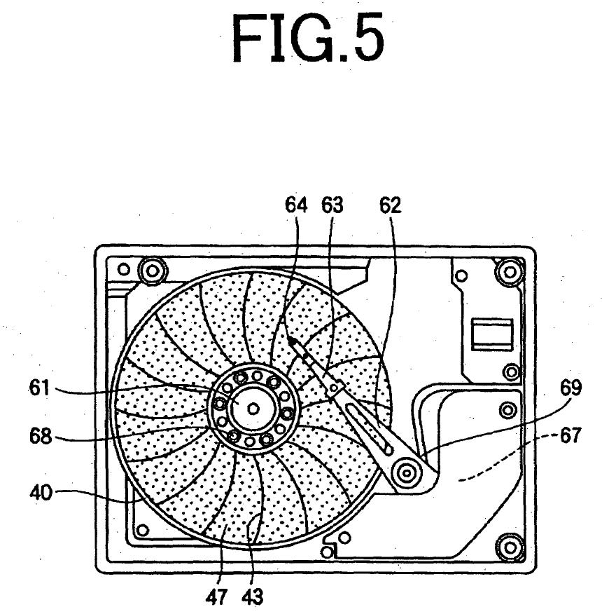

Then, as per FIG. 5, the patterned medium 40 is loaded on a spindle motor 61. The degree of the decentering is measured by scanning the patterned medium 40 from its outermost circumference with a head—which is incorporated in a slider 64 attached to an end of a micro-motion arm 63 with a base arm 62—which is operated by an actuator 67. Presumably the patterned medium has no circularity error caused in mold imprinting process, in other words, patterned medium has no high-order pattern error.

In FIG. 5, reference characters 43, 47, 68 and 69 denote the servo pattern region, the recording pit region, a disk clamp ring and a rotation axis, respectively.

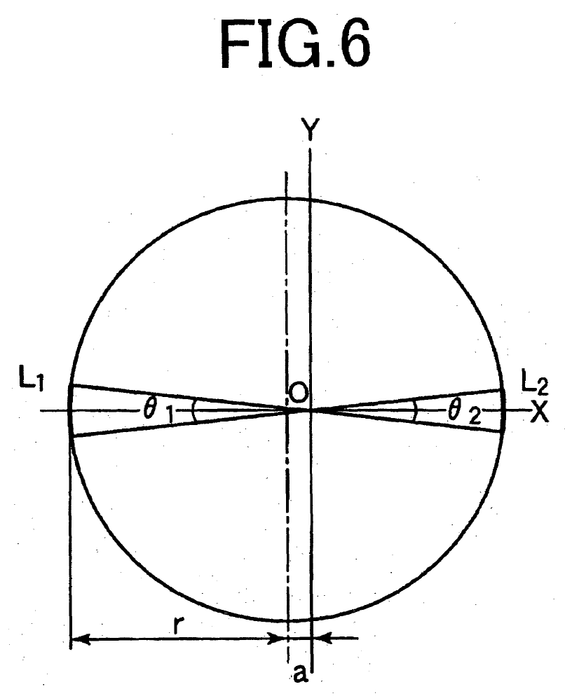

FIG. 6 illustrates a decentering between the center of the patterned medium and a rotating center of the spindle motor. For the patterned medium whose clock synchronous pattern and recording pits are synchronously formed on tracks of the patterned medium, a clock frequency F is constant at a certain number of revolutions where the rotation centers of the patterned medium and the motor agree. However, where the patterned medium whose center deviates from the rotation center of the spindle motor by “a”, the clock for the pattern reproduced with the head can be expressed by F±bHz when the patterned medium is rotating at the selected number of revolutions.

Assuming the rotation center of the spindle motor=XY coordinate origin, the degree of the decentering=a, a radius of the clock synchronous pattern=r, a length to 1 degree on the left circumference=L1 and a length to 1 degree on the right circumference=L2,

where an angle to the length L1 at the origin is defined as θ1,

and an angle to the length L2 at the origin is defined as θ2, thus

L1=(r−a)×θ1

L2=(r+a)×θ2

Provided that the clock synchronous pattern does not have any error except the decentering, L1=L2, therefore L1=(r−a)×θl=(r+a)×θ2=2. Thus, “a” can be written by a=r (θ1−θ2)/(θ1+θ2).

When the patterned medium rotates at the certain number of revolutions ω, a relationship between the clock frequency F is given by

F=r(F1−F2)/(F1+F2)

Therefore, where the patterned medium is decentered, the clock should be adjusted according to the degree of the decentering in order to exactly synchronize the clock to the pattern.

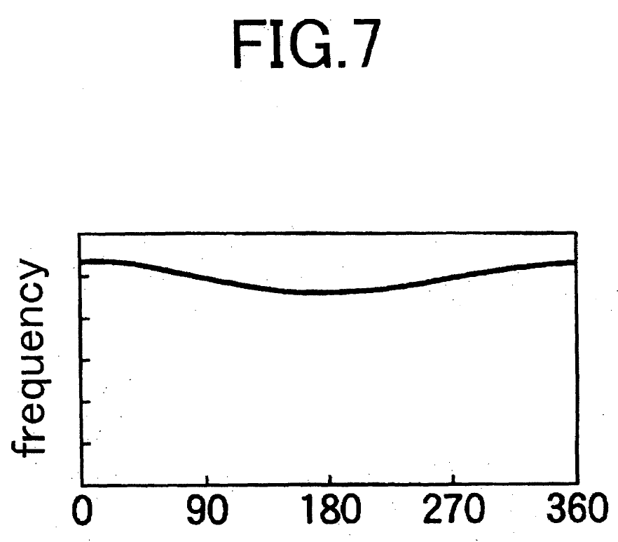

FIG. 7 shows a relationship between the circumference direction and the frequency where the patterned medium is decentered. Since the circumferential velocity on the L1 side is determined based on a radius r+a, the frequency becomes higher. By contrast, the circumferential velocity on the L2 side is determined based on a radius r−a, therefore the frequency becomes lower. Thus the frequency fluctuates sinusoidally as per FIG. 7.

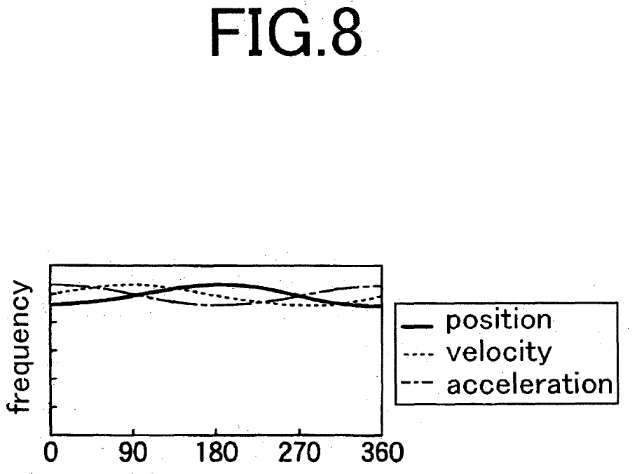

FIG. 8 shows the correlation of the head position and the current. For the magnetic disc device, the head follows the tracks decentered to the rotation center, thus current is applied to the actuator. The relationship between the head position and the current is as shown in FIG. 8.

Speed is obtained by differentiating the head position once, and an accelerated velocity a is obtained by differentiating the head position twice. Since mα=BiL, a current “i” applied to a coil of the actuator is proportional to the accelerated velocity α.

Here, m, B, L denote a mass of the head, a magnetic flux generated when the actuator moves the base arm, a length of the coil, respectively.

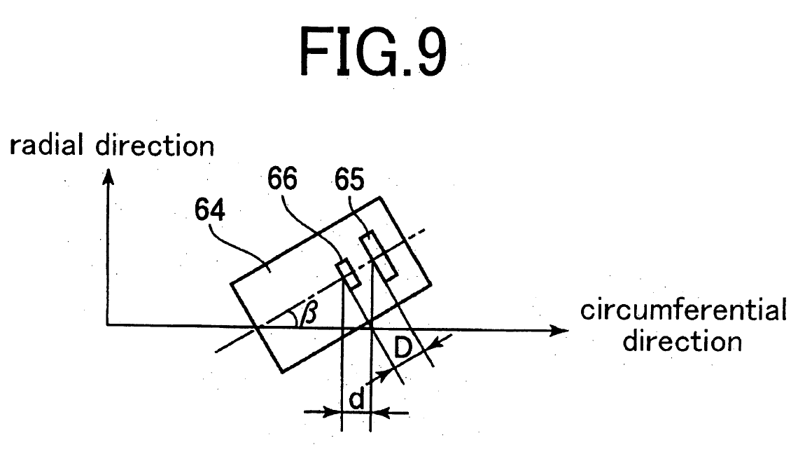

Furthermore, for a magnetic disk device, typically, the writing and the reading heads are positioned apart. In addition to that, the displacement of the writing/reading head attributed to the yawing angle β results in an asynchronous timing. Therefore the writing timing should compensate for this. Referring to FIG. 9, this process will be described.

FIG. 9 illustrates the displacement of the writing/reading head attributed to the yawing angle β. Where a distance between a writing head 65 and a reading head 66 formed in a slider 64 is defined as D, a displacement “d” in the circumferential direction of a disk is derived by

d=D cos β

In writing information on the disk, first a recording position is checked by the reading head 66, then the information is written by the writing head 65. As such, the writing timing delays by “d”.

To address this problem, the clock synchronous pattern on the medium and a clock for the reproduction signal of the drive are synchronized in a clock recovery region of the servo signal. Thereafter, the writing timing is delayed by d=D cos from the clock in creating writing clock signals.

Additionally, the reading/writing head should be offset by D sin β in the radius direction.

Further, the distance from the center of the reading head 66 to that of the writing head 65, D, differs from piece to piece so that measuring an actual distance D of the head incorporated in an individual drive is necessitated.

Thus the distance D is derived by: first recording the isolated pattern 51 in the continuous region 50i formed in each boundary region 42i with the writing head 65, then reading the isolated pattern 51 with the reading head 66, and thereafter comparing the reproduction signal with the writing clock.

Again, the amount of writing timing delay depends on the yawing angle β, so an amount of timing compensation should be derived according to the radius position “r”. Thereafter, the amount of the timing compensation derived is stored as a frequency table for each zone.

More precisely, the isolated pattern 51 with which “0s” can be distinctly distinguished from “1s” is recorded in the continuous recording medium region 50i formed in each boundary region 42i with the writing head 65. Then, the head is moved in the radial direction to read the reproduction signal at the point where the signal from the isolated pattern 51 is output. Thereby, extent to which the clock is asynchronous in the sector is measured as the amount of delay.

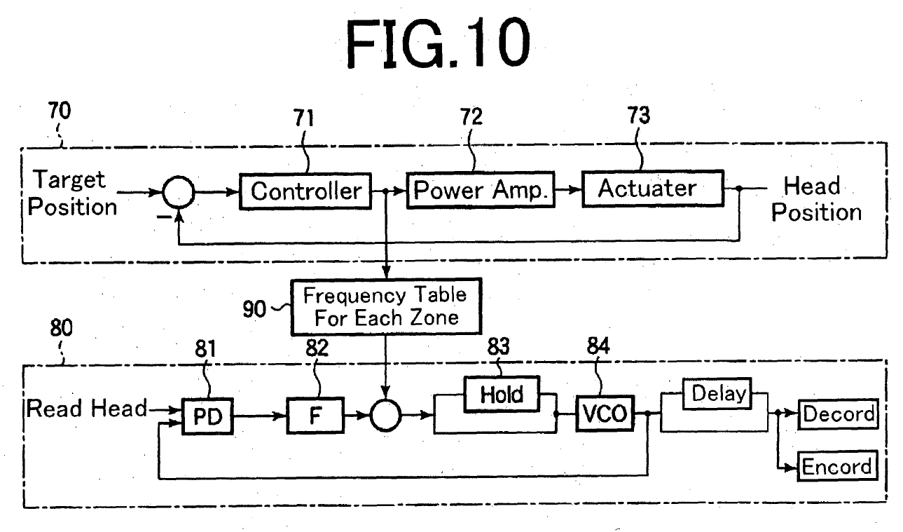

FIG. 10 shows a clock generator circuit in the first embodiment, which is constructed from a decentering compensation servo loop 70 and a clock compensation part 80.

The decentering compensation servo loop 70 includes a servo controller 71, a power amplifier 72, an actuator 73 and a feedback loop. Where the head focuses a track, the servo controller 71 computes the degree of decentering by feeding back the reproduction signal passed through the servo pattern at the head position. Based on the computation, frequency tables 90 for each zone are created and stored.

The clock compensation part 80 has a typical PLL having a phase detector 81, a loop filter 82, a sample-hold circuit 83 and a voltage control oscillator 84, and derives an amount of delay by the output of a clock signal from the voltage control oscillator 84.

This PLL is provided the decentering compensation information obtained from the frequency table 90 for each zone. When the head passes over the servo pattern, the sample-hold circuit 83 holds the output and provides it to the voltage control oscillator 84. When writing information, the sample-hold circuit 83 determines the amount of writing timing delay.

In the first embodiment, the frequency table is made as follows: the clock frequency F is changed according to the degree of the decentering “a”, and the adjusting amount for the writing timing asynchronous caused by the distance D attributed to the yawing angle is derived for each zone, and then changes of distance D attributed to the individual piece by the actual measurement. Thus the frequency asynchronous problem with the recording pit pattern formed on the patterned medium is not caused in the sector, thereby realizing a longer sector which improves the format efficiency.

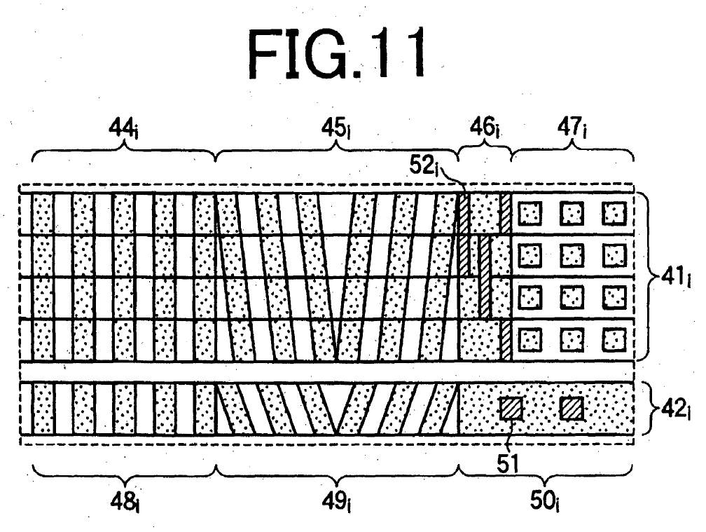

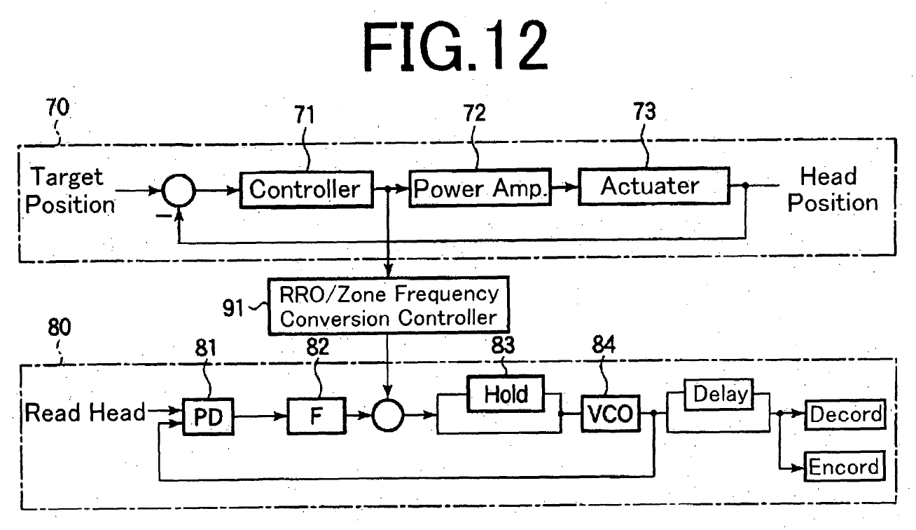

Next, referring to FIGS. 11 and 12, a clock generation method for the patterned medium in the second embodiment will be discussed.

The production process of the patterned medium in the second embodiment is as in the first embodiment. In the second embodiment, the clock generation method compensates for provided high-order decenterings of the patterned medium and the pattern thereon caused in the nanoimprint process.

The RRO of the patterned medium in the second embodiment is derived from a tracking error signal obtained by a conventional track-following control method.

An open-loop transfer function of the tracking servo is measured by tracking the patterned medium loaded on the drive from its outer circumference by a servomechanism.

FIG. 11 illustrates the servo pattern and the patterned medium pit pattern on the patterned medium in the second embodiment. As described above, the RRO is determined by the track position error signal and the open-loop transfer function. Then RRO data 52i is written magnetically at the end of the servo information region, i.e., the continuous recording medium region 46i where the servo pattern for each zone 41i is written with the writing head 65.

FIG. 12 shows the clock generator circuit in the second embodiment of this application, which comprises the decentering compensation servo loop 70 and the clock compensation part 80.

As in the first embodiment, the decentering compensation servo loop 70 comprises the servo controller 71, the power amplifier 72, the actuator 73 and the feedback loop. When the head focuses on a track, the servo controller 71 derives the degree of decentering by feeding back the reproduction signal passed through the servo pattern at the head position.

In recording/reproducing data, the servo controller 71 outputs the RRO data and zone data to a RRO/zone frequency conversion controller 91.

The clock compensation part 80 is a typical PLL having the phase detector 81, the loop filter 82, the sample-hold circuit 83 and the voltage control oscillator 84 as in the first embodiment, and determines the amount of delay by the output from the voltage control oscillator 84.

In the second embodiment, the PLL is provided the high-order decentering compensation information obtained by the RRO/zone frequency conversion controller 91. When the head passes over the servo pattern, the sample-hold circuit 83 holds the output and provides it to the voltage control oscillator 84. When writing information, the sample-hold circuit 83 determines the amount of writing timing delay.

In the second embodiment, the RRO is measured and written on the patterned medium magnetically as the servo pattern to utilize for head driving in writing/reading data into/from the recording bit region. Thus, even where the patterned medium has high-order decentering, the longer sector can be achieved without deteriorating the format efficiency.

This application includes but is not limited to the structures/conditions described in aforementioned embodiments and can be changed in a variety of ways. E.g., the number of zones on a 2.5-inch patterned medium is not limited to 100 and greater, but also 100 and below.

What is claimed is:

1. A clock generation method comprising:
detecting from a servo signal a degree of decentering of a patterned medium having recording pits arranged in a circular pattern corresponding a zone therein; and
changing a clock frequency for recording/reproduction based on the detected degree.

2. The clock generation method according to claim 1, further comprising measuring displacements between a reading head and a writing head in the circumferential direction when changing the clock frequency to generate a clock with compensation for a delay attributed to the measured displacement.

3. The clock generation method according to claim 1, wherein the changed frequency reflects a high-order component of the decentering.

4. A patterned medium comprising:
a plurality of concentric tracks divided into a plurality of zones in a radial direction;
recording pits arranged along said tracks in a pattern corresponding the zone therein; and
repeatable run-out (RRO) information recorded in a servo region of the zones.

5. The patterned medium according to claim 4, further comprising:
a continuous recording medium region formed across a boundary of said zones; and
an isolated pattern formed in said continuous recording medium region for measuring a displacement of the reading/writing head in the circumferential direction.

6. A storage device, comprising:
a patterned medium having a plurality of concentric tracks divided into a plurality of zones in a radial direction, recording pits arranged along said tracks in a pattern corresponding to the zone therein; and repeatable run-out (RRO) information recorded in a servo region of the zones;
a spindle motor loading said patterned medium; and
a clock frequency controller detecting the degree of the decentering of said patterned medium from a servo signal recorded thereon and changing the clock frequency for recording/reproduction based on the degree of the decentering.

7. The storage device according to claim 6, further comprising a table providing a relationship between said decentering and frequency for each zone.

8. The storage device according to claim 6, further comprising a table providing coefficients in the radius and the circumferential directions derived from said decentering.
